(19) United States
(12) Patent Application Publication
(10) Pub. No.: US 2025/0050641 A1
(43) Pub. Date: Feb. 13, 2025

(54) IMAGE FORMING APPARATUS TIMED MOVEMENTS

(71) Applicant: Hewlett-Packard Development Company, L.P., Spring, TX (US)

(72) Inventors: Wei Lit TEOH, Singapore (SG); Felicia REZANDA, Singapore (SG); Eric Scott COLLINS, Vancouver, WA (US)

(21) Appl. No.: 18/232,471

(22) Filed: Aug. 10, 2023

(51) Int. Cl. B41J 2/165; B41J 29/17

(52) U.S. Cl. CPC B41J 2/16535; B41J 29/17; B41J 2002/16576

(57) ABSTRACT

An example image forming apparatus may include a service station sled to move in a first direction into a wiper zone at a particular time and a print head carriage to move in a second direction out of the wiper zone at the particular time such that the service station sled and the print head carriage are moving at the particular time.

### BACKGROUND

An image forming apparatus can deposit a printing substance on to a print media to generate images on the print media. Image forming apparatuses may utilize a print media input tray to hold the print media. In some examples, an amount of print media in the print media input tray is determined so that print media can be replenished in a timely manner. In response to an amount of print media in the print media input tray being indicated to be low, a user/operator may be signaled to reload print media in the print tray.

### BRIEF DESCRIPTION OF THE DRAWINGS

FIG. 1 illustrates an example of a block diagram of an image forming apparatus.

FIG. 2A illustrates an example of a service station sled and a print head carriage of an image forming apparatus.

FIG. 2B illustrates an example of a service station sled and a print head carriage of an image forming apparatus.

FIG. 3A illustrates an example of print media pick positioning of a pick arm of an image forming apparatus.

FIG. 38 illustrates an example of idle or home positioning of a pick arm of an image forming apparatus.

FIG. 4 illustrates an example of a pick arm utilized for detecting a print media height of an image forming apparatus.

FIG. 5 illustrates an example of a method for movements of a service station sled and a print carriage of an image forming apparatus.

FIG. 6 illustrates an example of a memory resource for detecting a height of print media of an image forming apparatus.

### DETAILED DESCRIPTION

A user may utilize a computing device in various purposes, such as for business and/or recreational use. As used herein, the term “computing device” refers to an electronic device having a processor and a memory resource. Examples of computing devices include, for instance, a laptop computer, a notebook computer, a desktop computer, networking device (e.g., router, switch, etc.), and/or a mobile device (e.g., a smart phone, tablet, personal digital assistant, smart glasses, a wrist-worn device, etc.), among other types of computing devices. As used herein, a mobile device refers to devices that are (or can be) carried and/or worn by a user. For example, a mobile device can be a phone (e.g., a smart phone), a tablet, a personal digital assistant (PDA), smart glasses, and/or a wrist-worn device (e.g., a smart watch), among other types of mobile devices.

Computing devices can be utilized in combination with printing devices/image forming apparatuses to send image data to the printing devices. In this way, digital data from a computing device can be utilized to generate physical representations of the digital data on a substrate. As used herein, an image forming apparatus includes a device that can deposit a printing substance on to a substrate or print media to generate an image on the substrate. As used herein, a substrate can include a material that can receive a printing substance to generate a permanent or semi-permanent image on the material. In some examples, the image forming apparatus can include an inkjet printing device that can deposit an ink substance on a substrate to generate an image on the substrate.

In some examples, the image forming apparatus can deposit the printing substance through a plurality of dispense nozzles and/or a dispenser that includes a plurality of dispense nozzles. As used herein, a dispense nozzle can include a device or system that is used to dispense or propel droplets of a print substance on to a surface of a substrate or print medium. In some examples, the plurality of dispense nozzles and/or the dispenser that includes the plurality of dispense nozzles can be part of a print head. The print head can be coupled to a print head carriage utilized to carry the print head across the surface of the substrate or print medium.

In some examples, the image forming apparatus may include a service station. As used herein, a service station may be utilized to service a print head of the image forming apparatus. Servicing operations of the service station may include wiping, spitting, cleaning, lubricating, and/or capping of the print head, though examples are not so limited. The servicing operations may be performed at a specific location such as a wiper zone. A service station sled may house the service station.

In some examples, print media may be stacked in a print media input tray for use by the image forming apparatus. The image forming apparatus can include a motor to drive movement of a pick arm and a pick arm roller coupled to the pick arm utilized for drawing the print media from the print media input tray and into an area of the image forming apparatus in which the printing substance (e.g., ink, though examples are not so limited) is deposited. In some examples, the pick arm may be coupled to the service station sled of the image forming apparatus.

Further, in some examples, the pick arm may be utilized in determining a print media height of print media in the print media input tray. For example, a travel distance of the pick arm from an idle or home position to a print media pick position and/or an angle between the idle or home position of the pick arm and the print media pick position of the pick arm may be monitored. The image forming apparatus may indicate a low on paper (LoP) status dependent on a signal received in response to the travel of the pick arm. In some examples, the further the distance of travel of the pick arm and/or the greater the angle between the idle or home position and the print media pick position of the pick arm, the stronger the signal strength.

Image forming apparatuses may be manufactured to minimize space utilized by the image forming apparatus to accommodate small, compact working spaces and/or yield an aesthetic look. As such, device and/or image forming apparatus designs may limit the footprint of multiple devices within the image forming apparatus and the working area of the multiple devices. Minimizing the pick arm device size or minimizing space and allowable travel distance of the pick arm may result in a low or weak signal strength produced during travel of the pick arm. The low or weak signal strength and/or a combination of the low or weak signal strength and background noise of the image forming apparatus can interfere with an accurate monitoring of pick arm travel distance and an accurate indication of a LoP status. Further, device sizes and proximity between devices within the image forming apparatus can limit the distance of travel of the pick arm due to the overall smaller footprint of the image forming apparatus design.

Accordingly, to maintain signal strength produced by the travel of the pick arm, devices within the image forming apparatus may be moved out of area of operation of other devices prior to the pick arm operation of picking print media from the print media input tray. Sequential movement of such devices within the image forming apparatus can delay the pick arm operation of picking print media from the print media input tray increasing operation time of the image forming apparatus and yielding a slower first-page-out/first-copy-out time. Further, sequential movement of such devices can result in sequential movement of the pick arm. For example, the pick arm may be moved a particular distance and hesitate or stop to accommodate timing of movement of other devices and then continue with movement. Sequentially breaking up the movement of the pick arm can further lead to breaking up of the pick arm movement signal, weakening the signal, and reducing accuracy of indication of a LoP status.

The present disclosure relates to timed movements of the print head carriage in relation to the movements of the service station sled and the pick arm. Specifically, moving of the print head carriage from a servicing or wiper zone simultaneously with or at a particular time of moving of the service station sled into the wiper zone, enabling a continuous motion of the service station sled and accordingly the pick arm, extending the area of travel of the pick arm, minimizing the potential of the wiper coupled to the service station from contacting or interfering with the print head during the movement of the service station sled and pick arm to minimize potential damage to the print head, and increasing signal strength for monitoring of the print media height. Further, moving of the print head carriage simultaneously with or at a particular time while the service station sled and the pick arm coupled to the service station sled are moving into the wiper zone, can minimize the time involved in picking print media from the print media input tray and first-page-out/first-copy-out time. In this way, time to print can be reduced, efficiency and accuracy of the print media height and LoP status can be improved, and damage to the print head can be reduced.

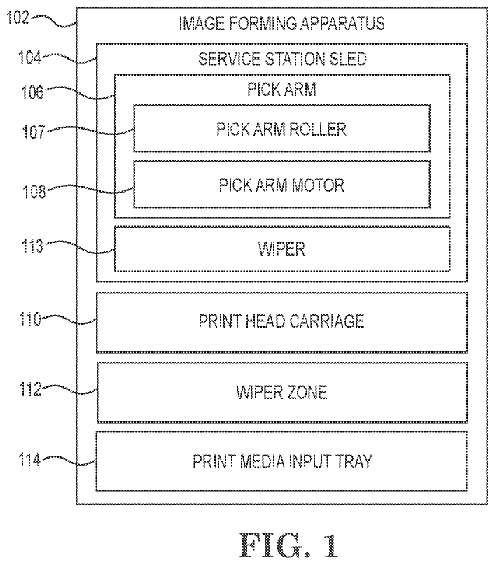

FIG. 1 illustrates an example of a block diagram of an image forming apparatus 102. As illustrated in FIG. 1, the image forming apparatus 102 may be a device that includes a service station sled 104, which may be physically connected or coupled to a service station of the image forming apparatus 102. The service station may be utilized to service a print head of the image forming apparatus 102. For example, the service station may provide service operations for the print head that include wiping, spitting, cleaning, lubricating, and/or capping of the print head, though examples are not so limited. As such, a wiper 113 may be coupled to the service station sled 104. Further, the service station sled 104 may be used to move the service station in a feed or paper axis direction of print media of the image forming apparatus 102. As used herein, a feed or paper axis direction of print media refers to the direction of travel the sheet of print media takes from a print media input tray through an image forming apparatus.

In some examples, the image forming apparatus 102 may include a print head carriage 110 utilized to house the print head. Additionally, the print head carriage 110 may be used to move the print head in a printing and/or scanning direction along an axis or move the print head transversely of the printing and/or scanning axis of the image forming apparatus 102. In some examples, the printing and/or scanning direction may be approximately perpendicular to the feed or paper axis direction of the print media. As used herein, the term “approximately” intends that the characteristic does not have to be absolute but is close enough so as to achieve the characteristic. For example, “approximately perpendicular” is not limited to absolute perpendicular. For instance, the printing and/or scanning direction can be within 0.5°, 1°, 2°, 5°, etc. of absolutely perpendicular to the print media feed direction.

In some examples, the image forming apparatus 102 may include a print media input tray 114. The print media input tray 114 can store sheets of unused print media for use by the image forming apparatus 102. The image forming apparatus 102 can further include a pick arm 106. A pick arm roller 107, utilized in picking the sheets of print media from the print media input tray 114, may be coupled to the pick arm 106. The pick arm roller 107 may be coupled to a distal end of the pick arm 106, though examples are not so limited. Further, the pick arm 106 can be coupled to a pick arm motor 108 used to drive the pick arm 106 and, accordingly, the pick arm roller 107, between an idle or home position and a print media pick position for drawing the print media from the print media input tray 114 and into an area of the image forming apparatus 102 in which the printing substances may be deposited.

In some examples, the image forming apparatus 102 can include a wiper zone 112. The wiper zone 112 may be utilized while servicing the print head, as previously described. In some examples, the service station sled 104 and the print head carriage 110 may move in and out of the wiper zone 112. For example, the service station sled 104 may move from a service station sled home location outside of the wiper zone 112 into the wiper zone 112. Accordingly, the wiper 113 may move into the wiper zone 112 as the service station sled 104 moves into the wiper zone 112. As further described herein, the pick arm 106, coupled to the service station sled 104, may move (e.g., may raise from the print media pick position to the idle or home position) as the service station sled 104 moves into the wiper zone 112.

In some examples, as the wiper 113 coupled to the service station sled 104 move into the wiper zone 112, the wiper 113 may move into the print head carriage home position and utilize the same area of the image forming apparatus 102 as the print head of the print head carriage 110. As such, to minimize an occurrence of interference between the wiper 113 and the print head of the print head carriage 110, the print head carriage 110 may move out of the print head carriage home position within the wiper zone 112. For example, the service station sled 104 may move from a home position and into the wiper zone 112 as the print head carriage 110 moves from a print head carriage home location within the wiper zone 112 to outside of the wiper zone 112. The print head carriage 110 may move simultaneous with or at a particular time corresponding to the movement of the service station sled 104, as described further herein, In this way, the print head carriage 110 may move out of the wiper zone 112 as the service station sled 104 moves into the wiper zone 112 minimizing occurrence of the wiper 113 interfering with and/or making contact with the print head of the print head carriage 110 and reducing the occurrence of damage to the print head.

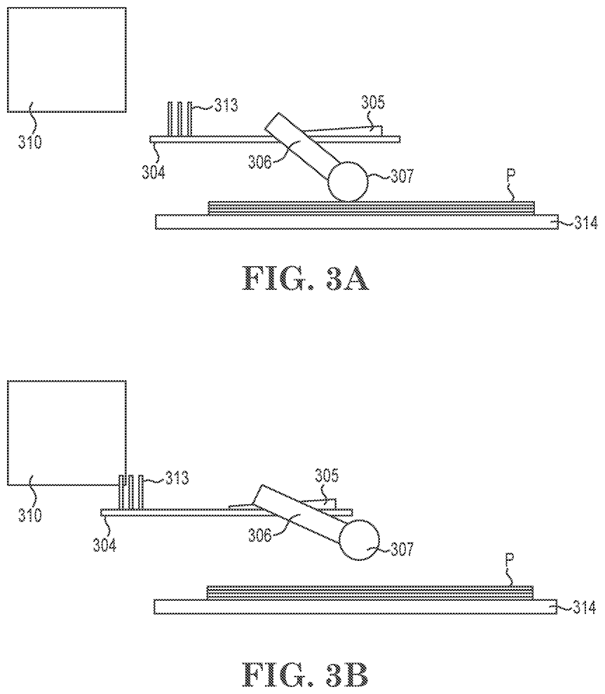

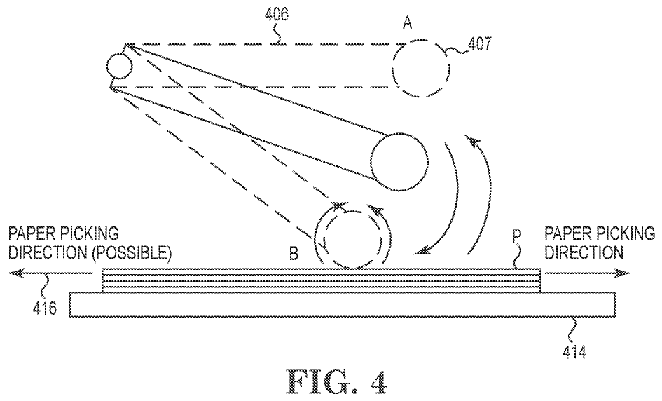

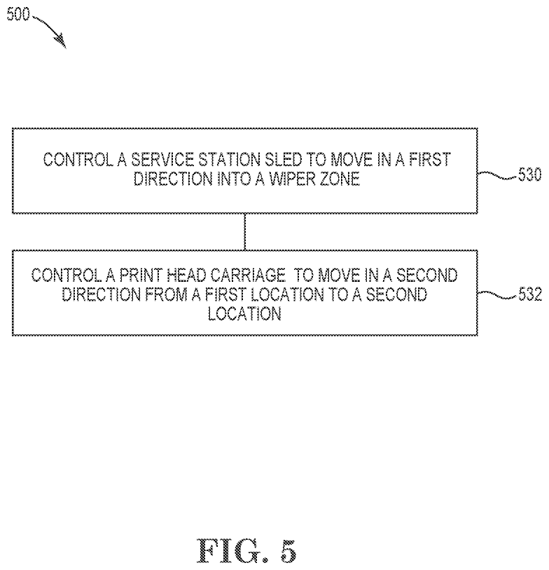

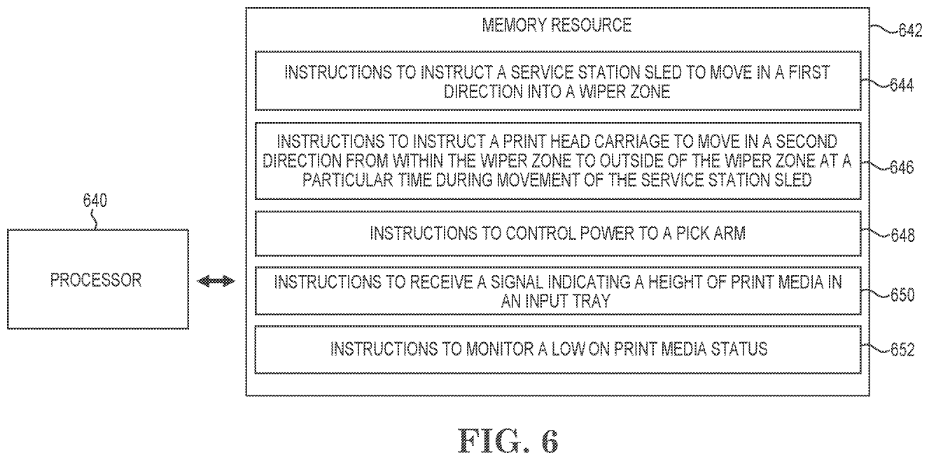

Additionally, as the service station sled 104 moves into the wiper zone 112, the pick arm 106 may move from the print media pick position to the idle or home position. As described further in relation to FIGS. 3A and 3B, the service station sled 104 can travel into an area previously occupied by the print head carriage 110. As such, moving the print head carriage 110 outside of the wiper zone 112 can allow for a larger travel distance of the service station sled 104 and the pick arm 106 than if the print head carriage 110 were to remain in the wiper zone 112. In some examples, the larger the travel distances of the pick arm 106 the greater or stronger the signal strength detected from the travel of the pick arm 106, Further, as the print head carriage 110 moves out of the wiper zone 112 at the same time as the service station sled 104 moves into the wiper zone 112 the service station sled 104 may move into the wiper zone 112 in one continuous motion. As such, the pick arm 106 may move between the print media pick position and the idle or home position in one continuous motion resulting in a continuous signal. Moving the pick arm 106 in a continuous motion may result in a stronger signal than moving the pick arm 106 in a sequential motion. Accordingly, stronger signal strengths can increase accuracy of a LoP status of the print media input tray 114 of the image forming apparatus 102.

Further, simultaneously moving the print head carriage 110 and the service station sled 104 and/or moving the print head carriage 110 at a particular time corresponding to movement of the service station sled 104 can reduce operation time of the image forming apparatus, increase efficiency, and may reduce costs of operation and energy consumption.

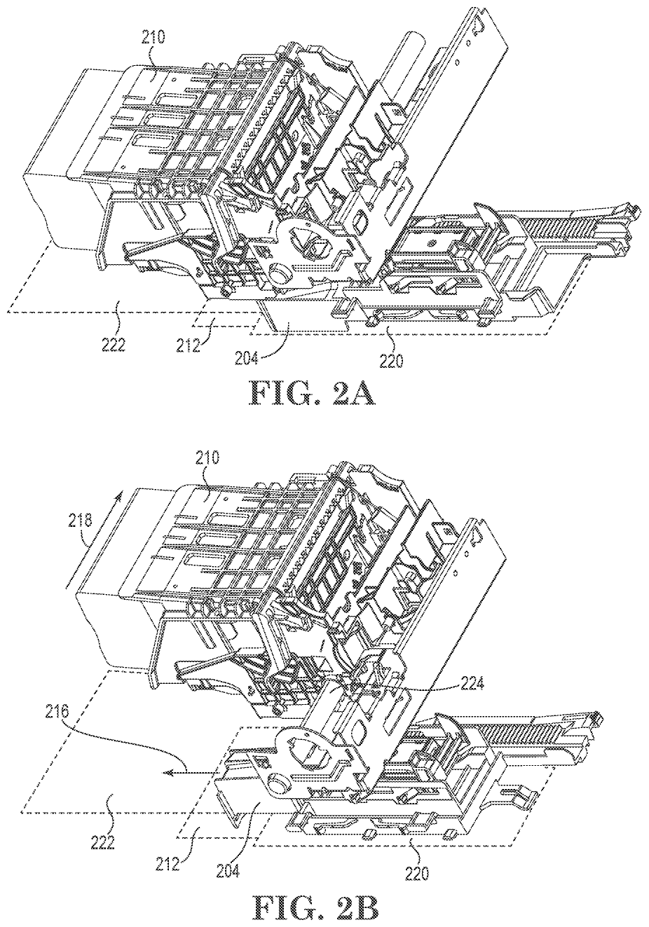

FIG. 2A illustrates an example of a service station sled 204 and a print head carriage 210 of an image forming apparatus. In some examples, the image forming apparatus includes the same or similar elements as image forming apparatus 102 as referenced in FIG. 1. For example, the image forming apparatus can include the service station sled 204 and the print head carriage 210. As illustrated in FIG. 2A, the service station sled 204 may be in a service station sled home position 220. The service station sled home position 220 may be located outside of a wiper zone 212 of the image forming apparatus. Further, as illustrated in FIG. 2A, the print head carriage 210 may have a print head carriage home position 222. The print head carriage home position 222 may be located within the wiper zone 212 of the image forming apparatus.

In some examples, the service station sled 204 may be in the service station sled home position 220 and the print head carriage 210 may be in the print head carriage home position 222 while the image forming apparatus is in an idle state (e.g., not printing, scanning, picking a sheet of print media, etc.).

FIG. 2B illustrates an example of a service station sled 204 and a print head carriage 210 of an image forming apparatus. In some examples, the image forming apparatus includes the same or similar elements as image forming apparatus of FIG. 1 and of FIG. 2A. For example, the image forming apparatus can include the service station sled 204 and the print head carriage 210.

In some examples, the image forming apparatus may receive an instruction to perform a print job. As used herein, the term “print job” refers to the process of forming markings such as text and/or images by transferring a print material (e.g., ink) to a medium. In response to receiving the instruction to perform the print job, the service station sled 204 may move from a service station sled home position 220 into a wiper zone 212. The service station sled 204 may move into the wiper zone 212 in a first direction 216. The first direction 216 may be in the same or opposite direction in which print media is fed into the image forming apparatus (e.g., a paper axis direction of the print media). In some examples, the service station sled 204 may move in the first direction 216 into the wiper zone 212 at a particular time. The particular time may be after the image forming apparatus has received the instruction to perform the print job, though examples are not so limited.

Further, in response to receiving the instruction to perform the print job, the print head carriage 210 may move from a print head carriage home position 222 within the wiper zone 212 to outside of the wiper zone 212. In this example, the print head carriage home position 222 may be located within the wiper zone 212 of the image forming apparatus. The print head carriage 210 may move outside of the wiper zone 212 in a second direction 218. The second direction 218 may be different than the first direction 216. For example, the second direction 218 may be in the same direction as a printing and/or scanning axis 224 of the image forming apparatus. Further, the second direction 218 may be approximately perpendicular to the first direction 216 and the printing and/or scanning axis 224 direction may be approximately perpendicular to the paper axis direction, though examples are not so limited.

In some examples, the print head carriage 210 may move in the second direction 218 out of the wiper zone 212 at the particular time. That is, the print head carriage 210 may move in the second direction 218 out of the wiper zone 212 at the particular time such that the service station sled 204 and the print head carriage 210 are moving at the particular time (e.g., simultaneously). Accordingly, the print head carriage 210 may move from the print head carriage home position 222 located in the wiper zone 212 to outside of the wiper zone 212 at the particular time during the movement of the service station sled 204 from the service station sled home position 220 into the wiper zone 212.

In some examples, the print head carriage 210 may begin moving from the print head carriage home position 222 located in the wiper zone 212 after the service station sled 204 has moved a particular distance. For example, the service station sled 204 may begin moving in the first direction 216. After the service station sled 204 has moved the particular distance in the first direction 216 from the service station sled home position 220 and into the wiper zone 212, the print head carriage 210 may begin to move in the second direction 218 from the print head carriage home position 222 within the wiper zone 212 at the particular time. As such, the print head carriage 210 may move in the second direction 218 and the service station sled 204 may move in the first direction 216 at the particular time (e.g., simultaneously).

As is described further in relation to FIG. 3, in some examples, the image forming apparatus may further include a pick arm (306 as shown in FIG. 3) coupled to the service station sled 204. As the service station sled 204 moves from the service station sled home position 220, the pick arm may move between an idle or home position (e.g., a pick arm home location) and a print media pick position.

FIG. 3A illustrates an example of print media pick positioning of a pick arm 306 of an image forming apparatus. In some examples, the image forming apparatus includes the same or similar elements as image forming apparatus of FIG. 1. For example, the image forming apparatus can include a wiper 313, coupled to a service station sled 304, and a print head carriage 310.

In some examples, the service station sled 304 can further include a pick arm lift cam 305. A pick arm 306 may be coupled to the service station sled 304 at the pick arm lift cam 305 of the service station sled 304. The pick arm 306 may include a pick arm roller 307 for picking print media P from a print media input tray 314 of the image forming apparatus.

In some examples, the service station sled 304 may be in a service station sled home position (220 as illustrated in FIG. 2A) and the print head carriage 310 may be in a print head carriage home position (222 as illustrated in FIG. 2A). As illustrated in FIG. 3A, while the service station sled 304 is in the service station sled home position and the print head carriage 310 is in the print head carriage home position the pick arm roller 307 may rest on top of the print media P of the print media input tray 314. Accordingly, the pick arm may be in a print media pick position. In some examples, while in the print media pick position, the pick arm roller 307 may feed print media P into the image forming apparatus.

FIG. 3B illustrates an example of idle or home positioning of a pick arm of an image forming apparatus. In some examples, the image forming apparatus includes the same or similar elements as image forming apparatus of FIG. 1. For example, the image forming apparatus can include a wiper 313, coupled to a service station sled 304, and a print head carriage 310.

As previously described in relation to FIG. 3A, in some examples, the service station sled 304 can further include a pick arm lift cam 305. A pick arm 306 may be coupled to the service station sled 304 at the pick arm lift cam 305 of the service station sled 304 and the pick arm 306 may include a pick arm roller 307 for picking print media P from a print media input tray 314 of the image forming apparatus.

In some examples, the service station sled 304 may move from a service station sled home position (220 as illustrated in FIG. 2A) into a wiper zone (212 as illustrated in FIG. 2B). As such, the service station sled 304 and the wiper 313 coupled to the service station sled 304 may move into the wiper zone in a first direction (216 as illustrated in FIG. 2B). Further, the pick arm lift cam 305 may move in the first direction. As the pick arm lift cam 305 moves in the first direction, the pick arm 306 coupled to the pick arm lift cam 305 may be lifted by the pick arm lift cam 305.

In some examples, while the print head carriage 310 is in the print head carriage home position (222 as illustrated in FIG. 2A) movement of the service station sled 304 may be limited due to the potential of interference between a print head of the print head carriage 310 and the wiper 313 of the service station sled 304, as illustrated in FIG. 3B. Interference between the print head and the wiper 313 may cause damage to the print head. Further, movement of the pick arm lift cam 305 coupled to the service station sled 304 may be limited, in turn limiting a travel distance of the pick arm 306. As the travel distance of the pick arm 306 is monitor for LoP status detection, limited travel distance of the pick arm 306 may result in a low or weak signal and an inaccurate LoP status detection.

Accordingly, the print head carriage 310 may move from a first location within the wiper zone (212 as illustrated in FIG. 2A) to a second location outside of the wiper zone. For example, the first position may be the print head carriage home position. In a situation where the service station sled 304 and the print head carriage 310 move in a sequential manner the service station sled 304 and the pick arm lift cam 305 may move a particular distance from the service station sled home position toward the wiper zone and hesitate or stop. The print head carriage 310 may then move from the first location within the wiper zone to the second position outside of the wiper zone. Upon completion of movement of the print head carriage 310, the service station sled 304 and the pick arm lift cam 305 may restart/continue movement into the wiper zone. In this situation, the movement of the service station sled 304 and the pick arm lift cam 305 is broken up or not continuous. A broken or non-continuous movement of the pick arm lift cam 305 may result in a broken or non-continuous movement of the pick arm 306 and signal received in response to the movement of the pick arm 306. A broken or non-continuous signal may result in a low or weak signal and an inaccurate LoP status detection.

In some examples, to minimize occurrence of a low or weak signal, the service station sled 304, print head carriage 310, and the pick arm lift cam 305 may move simultaneously. For example, the service station sled 304 may move in the first direction from the service station sled home position a particular distance. The print head carriage 310 may begin to move in a second direction (218 as illustrated in FIG. 2B) at a time in which the service station sled 304 has moved the particular distance. In some examples, movement of the print head carriage 310 may toggle power to a pick arm motor (108 as illustrated in FIG. 1) coupled to the pick arm lift cam 305 and the pick arm 306 off and on. As such, the pick arm lift cam 305 may begin to move in the first direction with the service station sled 304 at the time in which the service station sled 304 has moved the particular distance and the print head carriage 310 begins to move out of the wiper zone. As the service station sled 304 moves into the wiper zone the print head carriage 310 may move out of the wiper zone. The print head carriage 310 may move out of the wiper zone simultaneously with or at a particular time in which the service station sled 304 moves into the wiper zone, reducing an operation time of the image forming apparatus and broken or non-continuous movement of the service station sled 304 and pick arm lift cam 305, resulting in a continuous movement or travel of the pick arm 306. A continuous movement or travel of the pick arm 306 may result in a stronger signal/greater signal strength and a reduction in inaccuracy of a LoP status detection.

In this example, the print head carriage 310 may move the print head out of the wiper zone as the wiper 313 coupled to the service station sled 304 moves into the wiper zone. Accordingly, the occurrence of interference between the print head and the wiper 313 may be minimized reducing potential damage to the print head and enabling the service station sled 304 to move a greater distance in the first direction. As such, the pick arm lift cam 305 may move a greater distance in the first direction, in turn increasing the travel distance of the pick arm 306. As further described herein, a greater distance of travel of the pick arm 306 may result in a stronger signal/greater signal strength and a reduction in inaccuracy of a LoP status detection.

FIG. 4 illustrates an example of a pick arm 406 utilized for detecting a print media height of an image forming apparatus. In some examples, the image forming apparatus includes the same or similar elements as image forming apparatus of FIG. 1 and FIGS. 3A and 3B. For example, the image forming apparatus may include the pick arm 406. The pick arm 406 may be coupled to a service station sled (304 as illustrated in FIGS. 3A and 3B) of the image forming apparatus.

In some examples, the image forming apparatus may further include a print media input tray 414. The print media input tray 414 may be located below the pick arm 406, though examples are not so limited. As the service station sled moves from a service station sled home position (220 as illustrated in FIGS. 2A and 2B) into a wiper zone (212 as illustrated in FIGS. 2A and 2B) in a first direction 416 or paper axis direction of print media P, the pick arm 406 may move from a print media pick position B to a pick arm idle or home position A. In some examples, a feed direction (e.g., Paper Picking Direction) of the print media P may be the opposite direction of the first direction 416 and/or in some examples, the feed direction (e.g., Paper Picking Direction (possible)) of the print media P may be the same direction as the first direction 416.

For example, the pick arm 406 may be coupled to a pick arm motor (108 as illustrated in FIG. 1). As previously described herein, a print head carriage (210 as illustrated in FIG. 2B) may move in a second direction (218 as illustrated in FIG. 2B). The print head carriage may begin moving in the second direction after the service station sled has moved a particular distance toward the wiper zone. In some examples, movement of the print head carriage may control power supplied to the pick arm motor. For example, movement of the print head carriage may turn power on and off to the pick arm motor. As such, after the service station sled has moved in the first direction a particular distance the print head carriage may begin moving outside of the wiper zone and may control the pick arm motor to transition the pick arm 406 between the print media pick position B and the idle or home position A.

Further, the image forming apparatus may monitor a distance in which the pick arm 306 travels. For example, the image forming apparatus may monitor the distance between the pick arm 406 idle or home position A and the pick arm 406 print media pick position B. As described herein, the distance of travel of the pick arm 406 between the idle or home position A and the print media pick position B and/or an angle between the idle or home position A and the print media pick position B may indicate a print media height.

As an example, an operating torque of the pick arm motor may be monitored. The operating torque may be defined as the instantaneous output torque of the motor from moving the pick arm 406. The operating torque may be correlated to the distance in which the pick arm 406 travels. For example, the operating torque may be monitored while the pick arm 406 is moved between the idle or home position A and the print media pick position B. In some examples, the idle or home position A may be a particular position in which a pick arm roller 407 is not in contact with print media P in the print media input tray 414. For example, the idle or home position A may be a position at which the pick arm 406 is approximately parallel to the print media input tray 414, though examples are not so limited. The pick arm 306 may move to the idle or home position A as part of a measurement of height of the print media P in the print media input tray 414. In some examples, the pick arm 406 may be in the idle or home position A while the image forming apparatus is in an idle state (e.g., while a print job is not being performed by the image forming apparatus). Additionally, while in the idle or home position A, the pick arm 406 may not be in contact with print media P present in the print media input tray 414.

In some examples, while the pick arm 406 is in the print media pick position B, the pick arm roller 407 may be in contact with the print media P in the print media input tray 414 and may be operated to draw or feed the print media P from the print media input tray 414 into the image forming apparatus. For example, while the image forming apparatus is performing a print job, the pick arm 406 may be moved to and remain in the print media pick position B for feeding print media P into the image forming apparatus. In some examples, after completion of the print job, the pick arm 406 may be lifted by the pick arm motor from the print media pick position B to the idle or home position A.

As the image forming apparatus performs the print job, print media P is fed into the image forming apparatus, and the amount of print media P in the print media input tray 414 is reduced. Accordingly, the operating torque of the pick arm motor to lift the pick arm 406 from the print media pick position B to the idle or home position A upon completion of the print job may vary depending on the amount or height of the print media P remaining in the print media input tray 414 after the completion of the print job. As the operating torque of the pick arm motor is monitored while the pick arm 406 is moved between the print media pick position B and the idle or home position A, an amount or height of print media P present in the print media input tray 414 may be determined.

For example, a lower print media height of print media P in the print media input tray 414 may result in a greater distance of travel of the pick arm 406 between the print media pick position B and the idle or home position A and thus a greater operating torque may be exhibited while lifting the pick arm 406 from the print media pick position B to the idle or home position A. As such, the amount or height of print media P may be determined based on the operating torque and/or the distance the pick arm 406 travels between the print media pick position B and the idle home position A. Based on the determined amount or height of print media P in the print media input tray 414, a low on paper/print media (LoP) status may be determined. For example, the LoP status may be determined in response to the amount or height of print media P being below a threshold amount of print media.

In some examples, the image forming apparatus may monitor the operation torque of the pick arm motor and the distance of travel of the pick arm 406 based on a signal received as a result of the movement of the pick arm 406. As previously described, the farther the distance of travel of the pick arm 406, the greater the operating torque exhibited by the pick arm motor and the stronger the signal. In some cases, a minimal pick arm travel distance, a broken or non-continuous travel of the pick arm, background noise of the image forming apparatus and/or a combination thereof, may result in a low operating torque and thus a weak signal, A weak signal may result in an inaccurate determination of print media P amount or height and, in turn, an inaccurate determination of whether the print media P amount or height is below the threshold amount of print media P.

As such, moving the print head carriage out of the wiper zone prior to the pick arm 406 movement, allowing for more area of pick arm 406 movement (as described in relation to FIGS. 3A and 3B) and continuous pick arm movement, can minimize instances of receiving a weak signal, improving print media P amount and height detection, and minimizing inaccurate determination of a LoP status. Furthermore, moving the print head carriage outside of the wiper zone at a particular time while moving the service station sled into the wiper zone at the particular time (e.g., at the same time) can reduce first-page-out/first-copy-out time of the image forming apparatus, increasing efficiency.

FIG. 5 illustrates an example of a method 500 for movements of a service station sled and a print carriage of an image forming apparatus. In some examples, the method 500 is executable by a processor. For example, the method 500 may include elements that are stored on a non-transitory memory resource that are executed by a processor to perform the corresponding functions.

In some examples, the method 500 includes controlling a service station sled to move in a first direction into a wiper zone at 530. For example, the service station sled may be moved in the first direction from a service station sled home position into the wiper zone, as illustrated in FIG. 2B. The first direction may be in a paper axis direction of the image forming apparatus. The service station sled may be controlled to move into the wiper zone in response to a print job received and to be performed by the image forming apparatus. In some examples, movement of the service station sled into the wiper zone may be a continuous movement.

In some examples, the method 500 includes controlling a print head carriage to move in a second direction from a first location to a second location at 532. For example, the first location may be from within the wiper zone and the second location may be outside of the wiper zone. For example, the print head carriage may be moved in a second direction from a print head carriage home position inside the wiper zone to outside of the wiper zone, as illustrated in FIG. 2B. The second direction may be in a printing and/or scanning axis direction of the image forming apparatus. As such, the second direction may be different than the first direction. For example, the second direction may be approximately perpendicular to the first direction, though examples are not so limited. The print head carriage may be controlled to move from the first location within the wiper zone to the second location outside of the wiper zone at a particular time during a movement of the service station sled into the wiper zone.

In some examples, movement of the print head carriage from the first location may control power to a pick arm coupled to the service station sled. As such, movement of the print head carriage from the first location controlling power to the pick arm may, in turn, control activation of feeding of print media into the image forming apparatus by a pick arm roller coupled to the pick arm.

Further, the image forming apparatus may monitor the distance in which the pick arm travels between an idle or home position and a print media pick position. As such, the height of print media in a print media input tray of the image forming apparatus may be measured based on an angle between the pick arm idle or home position and the print media pick position and/or the distance between the idle or home position and the print media pick position. In some examples, the height of the print media in the print media input tray may be measured while the service station sled is within the wiper zone and the print head carriage is outside of the wiper zone. Further, in some examples, a low on paper or print media (LoP) status may be determined. The LoP may be determined based on the measure height of the print media in the print media input tray being below a threshold amount of print media. In this example, the measure height of the print media may be determined based on the monitored distance of movement of the pick arm between the idle or home position and the print media pick position.

FIG. 6 illustrates an example of a memory resource 642 for detecting a height of print media of an image forming apparatus. In some examples, the memory resource 642 is part of a computing device or controller that can be communicatively coupled to a computing system. For example, the memory resource 642 is part of an image forming apparatus 102 as referenced in FIG. 1. In some examples, the memory resource 642 is communicatively coupled to a processor 640 that executes instructions 644, 646, 648, 650, 652, stored on the memory resource 642. For example, the memory resource 642 is communicatively coupled to the processor 640 through a communication path. In some examples, a communication path includes a wired or wireless connection that allows communication between devices and/or components within a single device.

The memory resource 642 may be electronic, magnetic, optical, or other physical storage device that stores executable instructions. Thus, a non-transitory machine-readable medium (MRM) (e.g., a memory resource 642) may be, for example, a non-transitory MRM comprising Random-Access Memory (RAM), read-only memory (ROM), an Electrically-Erasable Programmable ROM (EEPROM), a storage drive, an optical disc, and the like. The non-transitory machine-readable medium (e.g., a memory resource 642) may be disposed within a controller and/or computing device. In this example, the executable instructions 644, 646, 648, 650, 652, can be “installed” on the device. Additionally, and/or alternatively, the non-transitory machine-readable medium (e.g., a memory resource 642) can be a portable, external or remote storage medium, for example, that allows a computing system to download the instructions 644, 646, 648, 650, 652, from the portable/external/remote storage medium. In this situation, the executable instructions may be part of an “installation package.” As described herein, the non-transitory machine-readable medium (e.g., a memory resource 642) can be encoded with executable instructions for establishing transfer locations.

In some examples, the memory resource 642 includes instructions 644 to instruct a service station sled to move in a first direction. The instructions 644 may include moving in the first direction into a wiper zone. Further, the instructions 644 may include moving in the first direction from a service station sled home position into a wiper zone. The memory resource 642 may instruct the service station sled to move into the wiper zone in response to an image forming apparatus receiving a print job.

In some examples, the memory resource 642 includes instructions 646 to instruct a print head carriage to move in a second direction. The instructions 646 may include moving in the second direction from a first location to a second location. In some examples the first location may be within the wiper zone and the second location may be outside of the wiper zone. The instructions 646 may further include moving in the second direction from within the wiper zone to outside of the wiper zone at a particular time during movement of the service station sled into the wiper zone. The second direction may be different than the first direction. For example, movement of the print head carriage in the second direction may be approximately perpendicular to the movement of the service station sled in the first direction.

Further, in some examples, the print head carriage may move from the first location within the wiper zone at the particular time that the service station sled has moved a particular distance into the wiper zone, as previously described herein.

In some examples, the memory resource 642 includes instructions 648 to control power to a pick arm. The instructions 648 may be in response to the movement of the print head carriage from the first location. For example, power to a motor coupled to the pick arm may be turned on or off in response to the movement of the print head carriage from the first location. The pick arm may include a pick arm roller to feed or draw print media into the image forming apparatus to perform the received print job.

In some examples, the memory resource 642 includes instructions 650 to receive a signal indicating a height of print media in a print media input tray. The signal may indicate a distance in which the pick arm travels to feed print media into the image forming apparatus. For example, the distance may be between a pick arm idle or home position and a pick arm print media pick position. In some examples, the distance in which the pick arm travels may be determined based on an angle between the pick arm idle or home position and the pick arm print media pick position. In some examples, the signal may be received while the service station sled is in the wiper zone and the print head carriage is outside of the wiper zone.

In some examples, the memory resource 642 includes instructions 652 to monitor a low on paper or print media (LoP) status. Monitoring the LoP status may include determining the LoP status based on the height of the print media in the print media input tray. The image forming apparatus may indicate a LoP status while the print media height is below a threshold amount of print media. The image forming apparatus may indicate that the print media input tray is low on print media and that print media may be added to prevent an out of print media status.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure. Further, as used herein, “a” refers to one such thing or more than one such thing.

The figures herein follow a numbering convention in which the first digit corresponds to the drawing figure number and the remaining digits identify an element or component in the drawing. For example, reference numeral 104 may refer to element 104 in FIG. 1 and an analogous element may be identified by reference numeral 204 in FIGS. 2A and 2B. Elements shown in the various figures herein can be added, exchanged, and/or eliminated to provide additional examples of the disclosure. In addition, the proportion and the relative scale of the elements provided in the figures are intended to illustrate the examples of the disclosure, and should not be taken in a limiting sense.

It can be understood that while an element is referred to as being “on,” “connected to”, “coupled to”, or “coupled with” another element, it can be directly on, connected, or coupled with the other element or intervening elements may be present. In contrast, while an object is “directly coupled to” or “directly coupled with” another element it is understood that are no intervening elements (adhesives, screws, other elements) etc.

The above specification, examples, and data provide a description of the system and methods of the disclosure. Since many examples can be made without departing from the spirit and scope of the system and method of the disclosure, this specification merely sets forth some of the many possible example configurations and implementations.

What is claimed is:

1. An image forming apparatus comprising:
a service station sled to move in a first direction into a wiper zone at a particular time; and
a print head carriage to move in a second direction out of the wiper zone at the particular time such that the service station sled and the print head carriage are moving at the particular time.

2. The image forming apparatus of claim 1, wherein the service station sled moves from a service station sled home position into the wiper zone.

3. The image forming apparatus of claim 2, wherein the print head carriage moves from a print head carriage home position located in the wiper zone to outside of the wiper zone at the particular time during a movement of the service station sled from the service station sled home position into the wiper zone.

4. The image forming apparatus of claim 1, further comprising a pick arm coupled to the service station sled wherein a pick arm roller coupled to the pick arm feeds print media into the image forming apparatus.

5. The image forming apparatus of claim 4, wherein movement of the print head carriage controls power supplied to a motor coupled to the pick arm.

6. The image forming apparatus of claim 4, wherein a distance of travel of the pick arm indicates a print media height.

7. The image forming apparatus of claim 1, wherein the second direction is perpendicular to the first direction.

8. A method, comprising:
controlling a service station sled to move in a first direction into a wiper zone in response to receiving a print job, wherein movement of the service station sled into the wiper zone is a continuous movement; and
controlling a print head carriage to move in a second direction from a first location that is within the wiper zone to a second location that is outside of the wiper zone in response to a particular time in the movement of the service station sled into the wiper zone;
wherein the second direction is perpendicular to the first direction.

9. The method of claim 8, further comprising controlling power to a pick arm in response to the moving of the print head carriage from the first location, wherein a pick arm roller coupled to the pick arm is to feed print media into an image forming apparatus.

10. The method of claim 8, further comprising measuring a height of print media in a print media input tray while the service station sled is within the wiper zone and the print head carriage is outside of the wiper zone.

11. The method of claim 10, further comprising:
monitoring a distance of movement of a pick arm coupled to the service station sled; and
determining a low on print media status based on the measured height of the print media, wherein the measured height of the print media is determined based on the monitored distance of movement of the pick arm.

12. A non-transitory machine-readable storage medium including instructions that when executed cause a processor of a printing device to:
instruct a service station sled to move in a first direction into a wiper zone;
instruct a print head carriage to move in a second direction, different than the first direction, from a first location that is within the wiper zone to a second location that is outside of the wiper zone at a particular time during a movement of the service station sled into the wiper zone;
control power to a pick arm in response to the movement of the print head carriage from the first location, wherein a pick arm roller coupled to the pick arm is to feed print media into an image forming apparatus;
receive a signal indicating a height of the print media in a print media input tray while the service station sled is in the wiper zone; and
monitor a low on print media status based on the height of the print media in the print media input tray.

13. The medium of claim 12, including instructions to cause the processor to cause the height of the print media to be monitored while the print head carriage is out of the wiper zone and based on the signal, wherein the signal further indicates a distance in which the pick arm travels to feed print media into the image forming apparatus.

14. The medium of claim 12, including instruction to cause the processor to instruct the print head carriage to move from the first location at the particular time that the service station sled has moved a particular distance into the wiper zone.

15. The medium of claim 12, wherein the movement of the print head carriage in the second direction is perpendicular to the movement of the service station sled in the first direction.
